(19) United States
(12) Patent Application Publication
(10) Pub. No.: US 2019/0197253 A1
(43) Pub. Date: Jun. 27, 2019

(54) METHOD, AN APPARATUS AND A COMPUTER PROGRAM PRODUCT FOR POSTHUMOUS MANAGING OF CONTENT

(71) Applicant: Emonum Oy, Lappeenranta (FI)

(72) Inventor: Ville Hyyrylainen, Lappeenranta (FI)

(21) Appl. No.: 15/852,836

(22) Filed: Dec. 22, 2017

(51) Int. Cl. G06F 21/62; G06F 21/60

(52) U.S. Cl. CPC G06F 21/6245; G06F 21/604

(57) ABSTRACT

The invention relates to a method, comprising accessing, by a server storing a plurality of user accounts, dying information; determining a user account from the plurality of user accounts based on the dying information; setting a time of death to the user account based on the dying information; determining a locking time for the user account based on the time of death, wherein the locking time is determined as a point in time before the time of death; accessing content stored in the user account, wherein the content has been stored before the locking time; accessing predefined distribution settings for distributing the content; and distributing the content according to the distribution settings.

### TECHNICAL FIELD

This invention relates to posthumous managing of content.

### BACKGROUND

Most people nowadays have digital assets in different forms, e.g. text, images, videos and music. Digital assets may be stored in a plurality of devices, such as personal computers, mobile devices and external hard drives. In addition, people may save digital assets in cloud services and social media services. Some of the digital assets are published or shared by a user such that other people can see, listen or read it. However, some of the content is such that the user does not want to share.

When the user passes away, it may be difficult to manage the digital assets of the user. For example, accounts of social media services may be closed. Content stored in external hard drives or cloud services may get lost if no one else has rights to access the content. If the loved ones can get access to the content, e.g. by hacking, there may be some content that the user would not have wanted to show to other people. For example, the content may be embarrassing or otherwise such that the user would like to keep the content in secret.

It may be difficult to manage the digital assets when planning what to do with those assets in case of death.

### SUMMARY OF THE INVENTION

Now there has been invented a method and technical equipment implementing the method, by which the above problems are alleviated. Various aspects of the invention include a method, an apparatus and a computer readable medium comprising a computer program stored therein, which are characterized by what is stated in the independent claims. Various embodiments of the invention are disclosed in the dependent claims.

According to a first aspect, there is provided a method comprising accessing, by a server storing a plurality of user accounts, dying information; determining a user account from the plurality of user accounts based on the dying information; setting a time of death to the user account based on the dying information; determining a locking time for the user account based on the time of death, wherein the locking time is determined as a point in time before the time of death; accessing content stored in the user account, wherein the content has been stored before the locking time; accessing predefined distribution settings for distributing the content; and distributing the content according to the distribution settings.

According to an embodiment, the method further comprises

determining a first time capsule between the locking time and the time of death; and
preventing distribution of content stored during the first time capsule.

According to an embodiment, the locking time is determined as substantially 24 hours before the time of death.

According to an embodiment, the method further comprises

determining a second time capsule between a time point before the locking time and the locking time;
distributing content provided during the second time capsule after verification.

According to an embodiment, the distribution settings comprise a destination and a triggering event; and the method further comprises

receiving an indication that the triggering event has occurred;
distributing, in response to the indication, the content to the destination.

According to an embodiment, the content stored in the user account comprises one or more of
text files;
image files;
video files;
music files; and
instructions to control another service.

According to a second aspect, there is provided an apparatus comprising at least one processor, a memory storing computer program product, said computer program product comprising computer-readable instructions that cause the apparatus to: store a plurality of user accounts; access dying information; determine a user account from the plurality of user accounts based on the dying information; set a time of death to the user account based on the dying information; determining a locking time for the user account based on the time of death, wherein the locking time is determined as a point in time before the time of death; access content stored in the user account, wherein the content has been stored before the locking time; access predefined distribution settings for distributing the content; and distribute the content according to the distribution settings.

According to an embodiment, the apparatus is further caused to

determine a first time capsule between the locking time and the time of death; and
prevent distribution of content stored during the first time capsule.

According to an embodiment, the apparatus is further caused to determine a second time capsule between a time point before the locking time and the locking time; and

distribute content provided during the second time capsule after verification.

According to an embodiment, the distribution settings comprise a destination and a triggering event; and the apparatus is further caused to receive an indication that the triggering event has occurred;

distribute, in response to the indication, the content to the destination.

According to a third aspect, there is provided a computer program product embodied on a non-transitory computer readable medium, comprising computer program code configured to, when executed on at least one processor, cause an apparatus to: store a plurality of user accounts; access dying information; determine a user account from the plurality of user accounts based on the dying information; set a time of death to the user account based on the dying information; determining a locking time for the user account based on the time of death, wherein the locking time is determined as a point in time before the time of death; access content stored in the user account, wherein the content has been stored before the locking time; access predefined distribution settings for distributing the content; and distribute the content according to the distribution settings.

According to an embodiment, the computer program product further causes the apparatus to:

determine a first time capsule between the locking time and the time of death; and
prevent distribution of content stored during the first time capsule.

According to an embodiment, the computer program product further causes the apparatus to determine a second time capsule between a time point before the locking time and the locking time;

distribute content provided during the second time capsule after verification.

According to an embodiment the distribution settings comprise a destination and a triggering event; and the computer program product further causes the apparatus to

receive an indication that the triggering event has occurred;
distribute, in response to the indication, the content to the destination.

### DESCRIPTION OF THE DRAWINGS

In the following, various embodiments of the invention will be described in more detail with reference to the appended drawings, in which

FIG. 1 shows, by way of example, a system for managing content;

FIG. 2 shows, by way of example, a block diagram of a server;

FIG. 3 shows, by way of example, a flowchart of a method for content management; and

FIG. 4 shows, by way of example, a flow of data after death.

### DESCRIPTION OF EXAMPLE EMBODIMENTS

This invention relates to a service for managing digital assets. In particular, the present embodiments are targeted to posthumous management of digital assets.

Many people prepare a will before passing away. Based on the will, the relatives know how a deceased person would have wanted to share the person's assets. In addition to physical assets, most people nowadays also have digital assets stored in a data storage, e.g. a server or an external hard drive. Devising digital assets is difficult, since a data storage may comprise files that a user would like to leave for one person, and the same data storage may comprise files that the user would like to keep secret from the person.

According to present embodiments, the user may decide that someone gets access to the digital assets, e.g. image files, video files, music files and text files, after death of the user. Alternatively or in addition, the user may decide that at least part of the digital assets will be published e.g. in a news service or in social media. In some cases, the user may want to postpone distribution or publication of at least part of the digital assets. A user who knows that she or he will die soon, e.g. due to a severe illness, may want to manage when someone will have access to certain assets. For example, the user may want that a heir will have access to certain assets in a certain age.

To “have access” means in this description that the digital asset, i.e. content, may be received by a predetermined person/persons in digital form, e.g. via e-mail or a text message. Alternatively or in addition, a predetermined person/persons may receive a link/an address, e.g. in a form of Uniform Resource Locator (URL), specifying location of the content on a computer network such as Internet. Predetermined person/persons may receive credentials, e.g. a password or a pin code, for accessing the content.

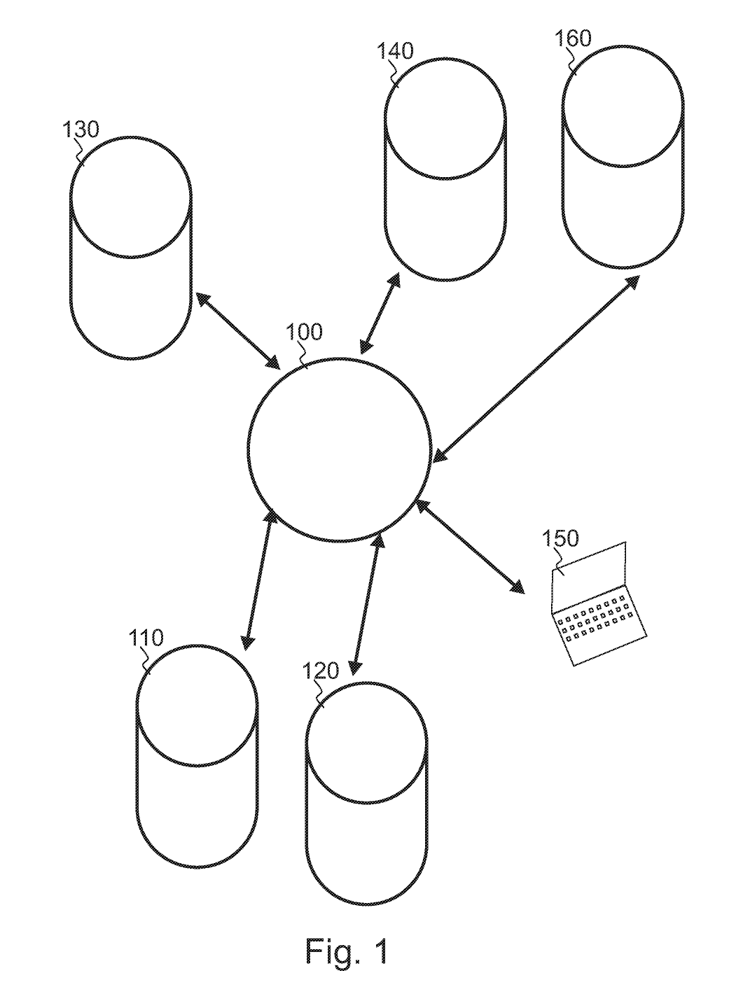

FIG. 1 shows, by way of example, a system for managing content. The content may comprise user's digital assets. The system comprises one or more databases. The databases are configured/arranged to communicate with each other via a communication network 100, e.g. Internet. The databases may be implemented in one or more servers 110, 120 and together they may form a server system such as a cloud. The one or more databases store user profiles relating to a digital asset management service. The user profiles contain user's personal digital assets, e.g. image files, video files, music files and text files or any other asset in digital form. The data relating to these assets are received as input from another data storage or a user device 150, such as a personal computer or a smart phone. The user may upload digital assets to the database.

The server(s) 110, 120 are further connected to one or more other servers providing data that is needed for implementing the present embodiments. For example, such third-party servers may include official population register 130, current and future social media services 140 (Facebook, LinkedIn, Twitter), one or more news agencies 160 and post offices and payment processing service. The data being provided by these other servers is discussed later in this description.

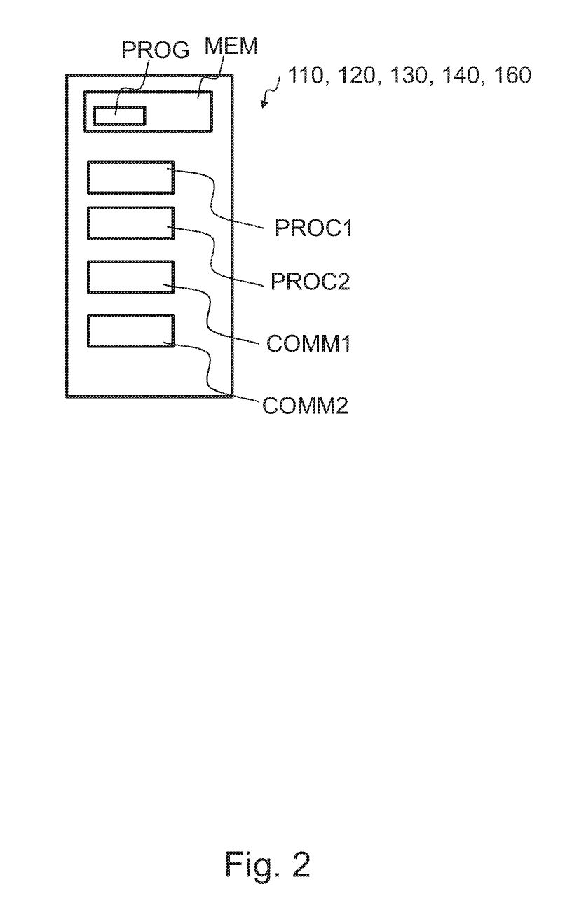

FIG. 2 shows, by way of example, a block diagram of the server(s) 110, 120, 130, 140, 160. The server 110 comprises memory MEM. The server comprises computer program code PROG residing in the memory MEM for implementing, for example, management of digital assets. The server comprises one or more processors PROC1, PROC2 that, when running the computer program code PROG, cause the server to carry out various embodiments of the method as disclosed herein. The elements of digital asset management process may be implemented as a software component residing in one server or distributed across several servers.

The server 110 may comprise communication modules COMM1, COMM2 for communicating with other devices, such as the third-party servers 130, 140, 160. The server may comprise circuitry and electronics for handling, receiving and transmitting data. The server may comprise these elements, or fewer or more elements.

The server may comprise a user interface that is displayed on the user device 150. By the user interface, the user is able to generate a user profile and to store digital assets to the service. In addition, the server may comprise other user interfaces for people having access to user's digital assets, and for administrating user.

When generating the user profile, the user provides personal data by which the user may be identified. The personal data may comprise e.g. name, family name, nick name, social security number or other user identification data, address, e-mail address and social media accounts. The user may upload content to the user account. The user determines the distribution settings for the content. The distribution settings may comprise e.g.
when the content will be shared (triggering event);
to whom the content will be shared (destination); and/or
to which service (blog, Facebook, Twitter) the content will be shared (destination).

If the distribution settings for the content comprise a person to whom the content will be distributed, personal data of the person has to be provided.

The personal data may comprise e.g. name, family name, nick name, social security number or other user identification data, address, e-mail address and social media accounts. The service may be connected to an official register by which the service may check the current personal data of the person based e.g. on the social security number. The person to whom the content will be distributed may also have created a user profile to the service. If so, the user profile of that person may be provided as the destination. In other words, the destination may be defined based on other user profiles stored in the server.

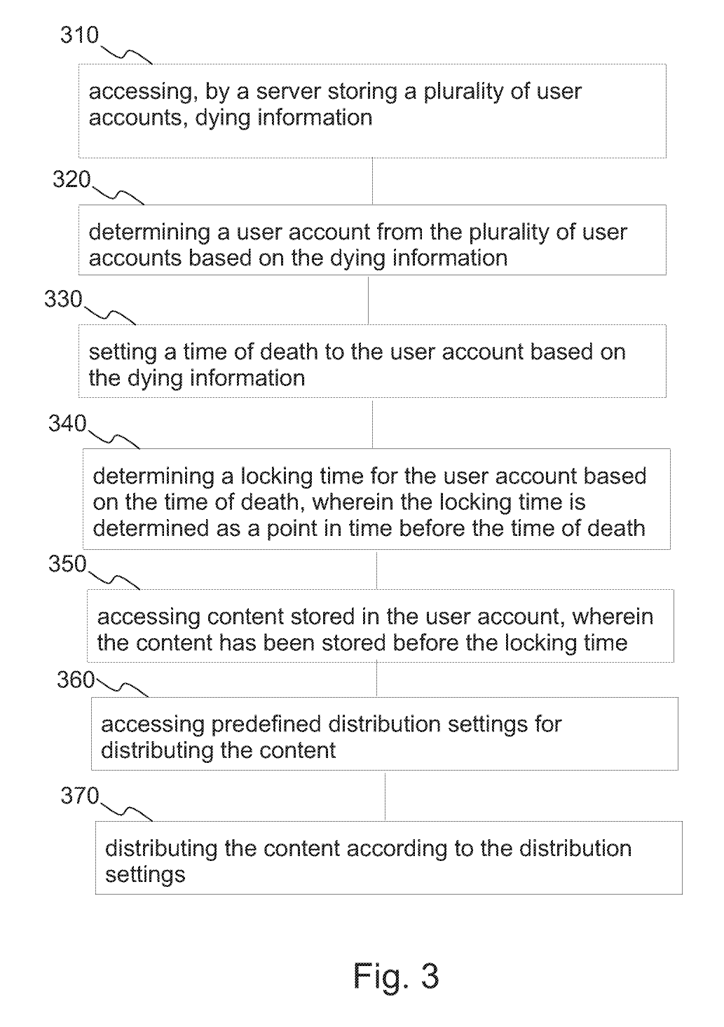

FIG. 3 shows, by way of example, a flowchart of the method for content management. The method comprises accessing 310, by a server storing a plurality of user accounts, dying information. The method comprises determining 320 a user account from the plurality of user accounts based on the dying information. The method comprises setting 330 a time of death to the user account based on the dying information. The method comprises determining 340 a locking time for the user account based on the time of death, wherein the locking time is determined as a point in time before the time of death. The method comprises accessing 350 content stored in the user account, wherein the content has been stored before the locking time.

The method comprises accessing 360 predefined distribution settings for distributing the content. The method comprises distributing 370 the content according to the distribution settings.

The server may communicate with an official population register or any other register managing population's birth and dying information. The server may receive dying information from the register. This may be implemented by receiving or by accessing e.g. once a day or once a week, or in real time, a list comprising deceased persons in the official population register and comparing the user profiles and the list of deceased persons. The comparison may be carried out e.g. by comparing the social security numbers or other user identification data between the user profiles and the list of deceased persons. If a match is found, it is determined that the person found on the list of deceased persons has generated a user profile in the service. A user corresponding to the dying information is determined based on the social security number or other user identification data. Corresponding dying information is received by the server.

Alternatively, the dying information may be determined based on ranking system of various social media accounts of the user or the dying information may be received and/or confirmed from relatives and/or friends of the user.

When the dying information is received from an official register, the dying information may comprise at least a social security number of the deceased person with or without a name of the person, and a time of death. The time of death comprises at least the date, and alternatively also a time of day. In addition, the dying information may comprise e.g. a time of birth, a place of death and a reason for death. A time of death is set for the user based on the dying information.

When the dying information is received from various social media accounts that are linked to the user profile in the present system, the dying information comprises at least the time of death.

A locking time is set for the user's account based on the time of death. There may be situations that the digital assets may comprise content which is contrary to public order or morality. For example, the content may be spur-of-the-moment suicidal notes or last messages relating to terrorist attacks and uploaded just before the attack. To avoid publication of this kind of harmful content, a locking time is set to a point in time before the time of death. Setting the locking time to a point in time before the time of death enables filtering of possible harmful content. Time capsule is determined as a time range between the locking time and the time of death. The locking time indicates a starting point for the time capsule. The time of death may indicate an end point for the time capsule. For example, the locking time may be set to 24 hours (h) before the time of death. 24 h may be suitable time for purposes of filtering of possible harmful content. Alternatively, the locking time may be set to e.g. 12 h or 48 h before the time of death. It is clear for a skilled person that the locking time may be set to a point in time before the time of death deviating from the given examples as long as it is suitable time for purposes of filtering of possible harmful content or annul actions caused by dishonest activities. Service provider managing the user profiles may determine duration of the time capsule. Alternatively, a plurality of time capsules may be determined, e.g. from 24 h before the time of death to the time of death, and from 48 h before the time of death to 24 h before the time of death.

In addition to the service provider, the user may determine duration of the time capsule. In other words, the user may define the point in time before the time of death to which the locking time is set. It may be made impossible for the user to change the locking time e.g. during the last 12 h, 24 h, or any suitable time before the time of death. If the user is severely ill and aware that his/her ability to make decisions is decreasing, the user may define the locking time such that the distribution of content stored after the locking time is prevented. This way the user can prevent storing of content that he/she probably does not understand anymore, and prevent other people, e.g. hackers, from abusing the account.

Processing rules may be determined for user input provided to the user profile during the time capsule(s). Different processing rules may be determined for different time capsules. The method may comprise determining a first time capsule between the locking time and the time of death. For example, the locking time is set 24 h before the time of death. The first time capsule is determined as from 24 h before the time of death to the time of death. Rule for the first time capsule may be that the user input provided after the locking time is not distributed. In other words, distribution of user input provided after the locking time is prevented. However, if the content is needed in investigations of official authorities, access for the authorities may be granted by the service provider.

Alternatively, rule for the first time capsule may be that the user input provided after the locking time is deleted.

The method may comprise determining a second time capsule between a time point before the locking time and the locking time. A second time capsule may be determined as from 48 h before the time of death to 24 h before the time of death. Rule for the second time capsule may be that the user input provided between 48 h-24 h before the time of death will be distributed selectively. This means that an administrator or an authorized person (e.g. trusted user described below) may check and/or verify the content before distributing. Checking and verification means that the content is read and/or watched in order to make sure that the content is not against common morality.

Rule for the user input provided before the first time capsule, or before the second time capsule if the second time capsule is determined, may be that such user input will be distributed or published according to the distribution settings determined by the user.

The method may comprise accessing saved user input and predefined distribution settings for distributing the saved user input. The distribution settings comprise at least a destination and a triggering event. The destination may be e.g. a social media account, someone's e-mail address or a blog. The triggering event may be e.g. a certain date, a certain time and/or a specific event. For example, the user may wish to send an electronic card or a music file to a relative every birthday after the user has passed away. As another example, distribution of the content may be set to be dependent on a specific event. The user may wish to publish a blog post if a person supported by the user will be elected as a president of a state, or if a war between some countries has ended.

The method may comprise receiving an indication that the triggering event has occurred. When the triggering event has occurred, the indication may be received from e.g. an internet calendar service or a news service. The indication of certain dates and/or time of day may be received from the server. The server comprises a real-time clock using coordinated universal time. In response to the indication that the triggering event has occurred, the saved user input will be distributed to the destination as defined in the distribution settings. For example, the user has stored a national anthem (a music file) of the user's country of origin in the user's profile in the service. The user has defined in the distribution settings that the national anthem should be distributed by sharing it on the social media account of the user on each national day after user has passed away. Thus, the national day is set as the triggering event. Each national day an indication is received that the triggering event has occurred. In response to the indication, the national anthem will be distributed on the social media account of the user.

As another example, the user has stored a letter (text file) in the user's profile. The user has defined in the distribution settings that the letter should be sent to the user's daughter if she will get married after the user has passed away. Marriage information may be received e.g. from magistrate or from a social media service, e.g. Facebook (marital status). In addition, the user may define in the distribution settings that the content will be deleted from the service if the triggering event has not occurred in a certain time. For example, the user may define that if the daughter has not got married before the date that the daughter has her 50-year-birthday, the letter will be deleted. As a further example, the user has defined in the distribution settings that a letter should be sent to the user's daughter if she will get divorced. The service may receive the divorce information e.g. from magistrate or from a social media service, e.g. Facebook (marital status).

As a further example, a band has composed a piece of music which it would like to publish posthumously i.e. when all the members of the band have deceased. If all the members have created a user profile to the service, the indication of the triggering events may be received internally from the service.

The distribution settings may comprise a note that a letter should be delivered by regular mail. In these cases the server may communicate with a post office which offers a service for sending a real letter in paper which will be created, e.g. printed or written, based on an electronic letter. The user may have paid the necessary payments beforehand to the service when determining the distribution settings. Alternatively the service may communicate with a payment processing service according to instructions determined in the distribution settings. The service will take care of paying the fees to the post office.

As a further example, the content stored in the user account may comprise money (in digital form) in addition to or instead of other content. In these cases the server may communicate with a money storage or a payment processing service. The distribution settings may comprise instructions for a payment to be made to someone after death of the user. There may be situations, wherein the user is forced by threatening to make payments to someone. Sometimes these kind of situations will end up to a homicide of the user. Determination of the locking time for the user account such that it is a point in time before the time of death is beneficial in the sense that such actions caused by dishonest activities may be annulled.

The users in the service may be connected to each other. In other words, the user has contacts in the service. The contacts may form groups. The user may define one or more contacts as trusted users. Trusted user may be e.g. authorized to confirm someone's dying information.

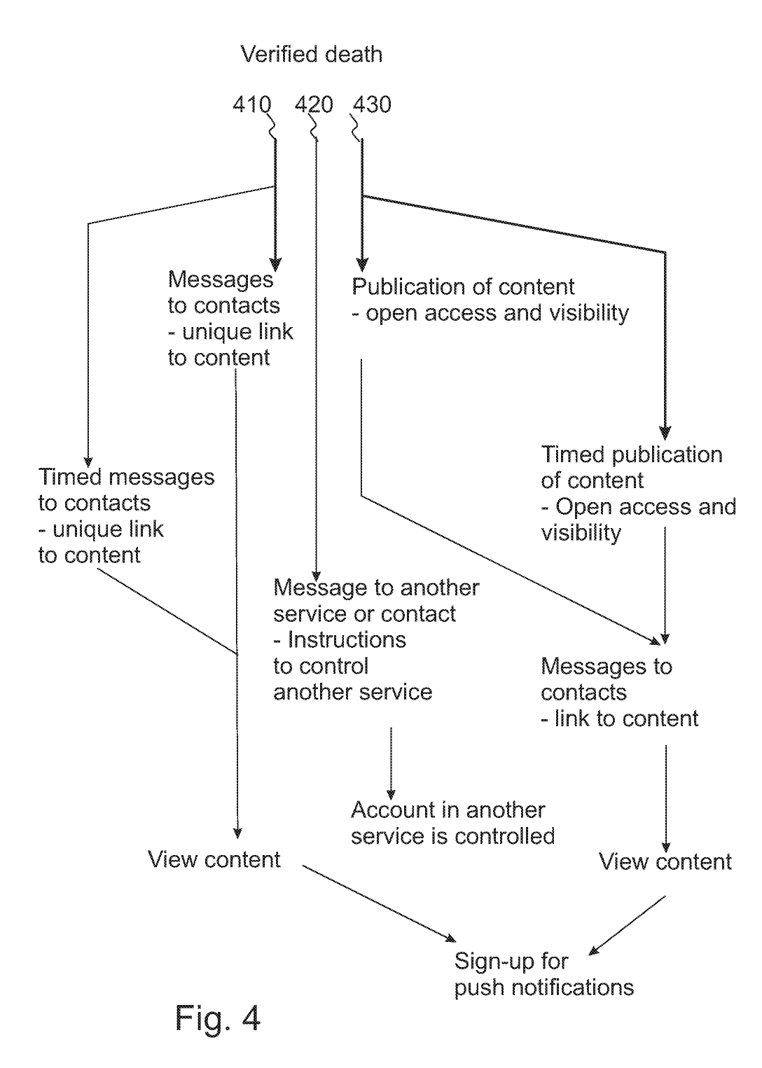

FIG. 4 shows, by way of example, a flow of data after death. The dying information may be verified by someone, e.g. the trusted user described above. After the death has been verified, the content stored in the user account is distributed according to the distribution settings. A first data route 410 is for such content that predefined persons, e.g. the contacts, will have access to. Messages to contacts may be sent shortly after the death (or verified death) or the messages may be timed. The messages may comprise unique link to the content, e.g. an URL to a cloud service. The recipient of the message may view the content using the unique link. It may be possible to sign-up for push notifications on future content release.

As a further example, the content stored in the user account may comprise instructions. A second data route 420 is for such content that comprises instructions. The instructions of the user may comprise instructions to control another service. For example, the instructions may comprise an order to close the accounts of the user in another social media services after death of the user. Alternatively, the instructions may comprise an order to e.g. delete the images in that account and keep the texts. The instructions may comprise an order to delete all the content in that account but to keep it open for other people, e.g. user's contacts or for persons determined by the user, to write memorials of the user and/or to upload images of the user to the memorial page. The user may have profiles e.g. in Facebook, LinkedIn and Instagram. The distribution settings may comprise another social media service as destination wherein the user has created an account or a user profile. Alternatively or in addition, a person, e.g. an authorized person, may be determined as destination. The person may be authorized to control another service, e.g. the accounts of the user after death of the user. Referring to the FIG. 4, a message may be sent shortly after the death (or verified death) to another service or a contact. Instructions may comprise an order to control another service. The account in another service is controlled based on the instructions.

A third data route 430 is for such content that will be published in a way that it is open for anyone. The content may be published shortly after the death (or verified death) or the publication may be timed. Messages may be sent to predefined persons, e.g. to the contacts, informing that content is public. The messages may comprise link to the content, e.g. an URL to a webpage. The recipients of the messages may view the content using the link. Alternatively or in addition, publication of the content may be announced such that anyone can be informed that content is public. For example, publication of the content may be announced in the webpage of the service. It may be possible to sign-up for push notifications on future content release.

In above, embodiments of a method for posthumous managing of digital assets have been disclosed. The method may be implemented by an apparatus comprising means for storing a plurality of user accounts; means for accessing dying information; means for determining a user account from the plurality of user accounts based on the dying information; means for setting a time of death to the user account based on the dying information; means for determining a locking time for the user account based on the time of death, wherein the locking time is determined as a point in time before the time of death; means for accessing content stored in the user account, wherein the content has been stored before the locking time; means for accessing predefined distribution settings for distributing the content; and means distributing the content according to the distribution settings. The means of the apparatus may comprise at least one processor, a memory, and a computer program being stored in the memory. The apparatus may be a network device, for example a server or many servers.

The present embodiments provide advantages. For example, the present embodiments enable a computer system to determine a potentially harmful content from a multiplicity of user data, and thus manage posthumous publication of digital assets by filtering out documents of spur-of-the-moment actions that have caused death of the user.

It is apparent that the present invention is not limited solely to the above-presented embodiments, but it can be modified within the scope of the appended claims.

What is claimed is:

1. A method, comprising:
accessing, by a server storing a plurality of user accounts, dying information;
determining a user account from the plurality of user accounts based on the dying information;
setting a time of death to the user account based on the dying information;
determining a locking time for the user account based on the time of death, wherein the locking time is determined as a point in time before the time of death;
accessing content stored in the user account, wherein the content has been stored before the locking time;
accessing predefined distribution settings for distributing the content; and
distributing the content according to the distribution settings.

2. The method according to claim 1, further comprising
determining a first time capsule between the locking time and the time of death; and
preventing distribution of content stored during the first time capsule.

3. The method according to claim 1, wherein the locking time is determined as substantially 24 h before the time of death.

4. The method according to claim 2, further comprising
determining a second time capsule between a time point before the locking time and the locking time;
distributing content provided during the second time capsule after verification.

5. The method according to claim 1, wherein the distribution settings comprise a destination and a triggering event; the method further comprising
receiving an indication that the triggering event has occurred;
distributing, in response to the indication, the content to the destination.

6. The method according to claim 1, wherein the content stored in the user account comprises one or more of
text files;
image files;
video files;
music files; and
instructions to control another service.

7. An apparatus comprising at least one processor, a memory storing computer program product, said computer program product comprising computer-readable instructions that cause the apparatus to:
store a plurality of user accounts;
access dying information;
determine a user account from the plurality of user accounts based on the dying information;
set a time of death to the user account based on the dying information;
determining a locking time for the user account based on the time of death, wherein the locking time is determined as a point in time before the time of death;
access content stored in the user account, wherein the content has been stored before the locking time;
access predefined distribution settings for distributing the content; and
distribute the content according to the distribution settings.

8. The apparatus according to claim 7, further caused to
determine a first time capsule between the locking time and the time of death; and
prevent distribution of content stored during the first time capsule.

9. The apparatus according to claim 7, wherein the locking time is determined as substantially 24 h before the time of death.

10. The apparatus according to claim 8, further caused to
determine a second time capsule between a time point before the locking time and the locking time;
distribute content provided during the second time capsule after verification.

11. The apparatus according to claim 7, wherein the distribution settings comprise a destination and a triggering event; and the apparatus is further caused to
receive an indication that the triggering event has occurred;
distribute, in response to the indication, the content to the destination.

12. The apparatus according to claim 7, wherein the content stored in the user account comprises one or more of
text files;
image files;
video files;
music files; and
instructions to control another service.

13. A computer program product embodied on a non-transitory computer readable medium, comprising computer program code configured to, when executed on at least one processor, cause an apparatus to:
store a plurality of user accounts;
access dying information;
determine a user account from the plurality of user accounts based on the dying information;
set a time of death to the user account based on the dying information;
determining a locking time for the user account based on the time of death, wherein the locking time is determined as a point in time before the time of death;
access content stored in the user account, wherein the content has been stored before the locking time;
access predefined distribution settings for distributing the content; and
distribute the content according to the distribution settings.

14. The computer program product according to claim 13, further causing the apparatus to:
determine a first time capsule between the locking time and the time of death; and
prevent distribution of content stored during the first time capsule.

15. The computer program product according to claim 13, wherein the locking time is determined as substantially 24 h before the time of death.

16. The computer program product according to claim 14, further causing the apparatus to
determine a second time capsule between a time point before the locking time and the locking time;
distribute content provided during the second time capsule after verification.

17. The computer program product according to claim 13, wherein the distribution settings comprise a destination and a triggering event; further causing the apparatus to
receive an indication that the triggering event has occurred;
distribute, in response to the indication, the content to the destination.

18. The computer program product according to claim 13, wherein the content stored in the user account comprises one or more of
text files;
image files;
video files;
music files; and
instructions to control another service.
